(19) United States
(12) Patent Application Publication
(10) Pub. No.: US 2005/0144015 A1
(43) Pub. Date: Jun. 30, 2005

(54) Automatic identification of optimal audio segments for speech applications

(75) Inventors: Ciprian Agapi, Lake Worth, FL (US); Felipe Gomez, Weston, FL (US); James R. Lewis, Delray Beach, FL (US); Vanessa V. Michelini, Boca Raton, FL (US); Sibyl C. Sullivan, Highland Beach, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 10/730,540

(22) Filed: Dec. 8, 2003

(51) Int. Cl. G10L 11/00

(52) U.S. Cl. 704/278

(57) ABSTRACT

A method and system of identifying and optimizing audio segments in a speech application program. Audio segments are identified and extracted from a speech application program. The audio segments containing audio text to be recorded are then optimized in order to facilitate the recording of the audio text. The optimization of the extracted audio segments may include accounting for programmed pauses and variables in the speech application code, identifying multi-sentence segments and the presense of duplicate audio segments, and accounting for the effects of coarticulation.

### BACKGROUND OF THE INVENTION

1. Statement of the Technical Field

The present invention relates to the field of interactive voice response systems and more particularly to a method and system that automatically identifies and optimizes planned audio segments in a speech application program in order to facilitate recording of audio text.

2. Description of the Related Art

In a typical interactive voice response (IVR) application, certain elements of the underlying source code indicate the presence of an audio file. In a well-designed application, there will also be text that documents the planned contents of the audio file. There are inherent difficulties in the process of identifying and extracting audio files and audio file content from the source code in order to efficiently create audio segments.

Because voice segments in IVR applications are often recorded professionally, it is time and cost effective to provide the voice recording professional with a workable text output that can be easily converted into an audio recording. Yet, it is tedious and time-intensive to search through the lines and lines of source code in order to extract the audio files and their content that a voice recording professional will need to prepare audio segments, and it is very difficult during application development to maintain and keep synchronized a list of segments managed in a document separate from the source code.

Adding to this difficulty is the number of repetitive segments that appear frequently in IVR source code. Presently, an application developer has to manually identify duplicate audio text segments and, in order to reduce the time and cost associated with the use of a voice professional and to reduce the space required for the application on a server, eliminate these repetitive segments. It is not cost productive to provide a voice professional with code containing duplicative audio segment text that contains embedded timed pauses and variables and expect the professional to quickly and accurately prepare audio messages based upon the code.

Further, many speech application developers pay little attention to the effects of coarticulation when preparing code that will ultimately be turned into recorded or text-to-speech audio responses. Coarticulation problems occur in continuous speech since articulators, such as the tongue and the lips, move during the production of speech but due to the demands on the articulatory system, only approach rather than reach the intended target position. The acoustic result of this is that the waveform for a phoneme is different depending on the immediately preceding and immediately following phoneme. In other words, to produce the best sounding audio segments, care must be taken when providing the voice professional with text that he or she will convert directly into audio reproductions as responses in an IVR dialog.

It is therefore desirable to have an automated system and method that identifies audio content in a speech application program, and extracts and processes the audio content resulting in a streamlined and manageable file recordation plan that allows for efficient recordation of the planned audio content.

### SUMMARY OF THE INVENTION

The present invention addresses the deficiencies of the art with respect to efficiently preparing voice recordings in interactive speech applications and provides a novel and non-obvious method and system for identifying planned audio segments in a speech application program and optimizing the audio segments to produce a manageable record of audio text.

Methods consistent with the present invention provide a method of identifying planned audio segments in a speech application program including identifying audio segments in the speech application program, where the audio segments contain audio text to be recorded and associated file names, extracting the audio segments from the speech application program, and processing the extracted audio segments to create an audio recordation plan. The step of processing the extracted audio segments may include accounting for programmed pauses and variables in the speech application code as well as identifying multi-sentence segments and the presence of duplicate audio segments. Finally, the step of processing the extracted audio segments may account for the effects of coarticulation.

Systems consistent with the present invention include a system for extracting and processing planned audio segments in a speech application program. The system includes a computer having a central processing unit, where the central processing unit operates to extract audio segments from a speech application program, the audio segments containing audio text to be recorded and associated file names, and to process the extracted audio segments in order create an audio recordation plan.

In accordance with still another aspect, the present invention provides a computer-readable storage medium storing a computer program which when executed identifies and processes planned audio segments in speech application program. The computer program includes extracting audio segments from a speech application program, where the audio segments contain audio text to be recorded and associated file names, and processes the extracted audio segments in order to create an audio recordation plan.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is flow chart illustrating the process of analyzing a speech application program and extracting text containing audio segments;

FIG. 2 is a listing of extracted audio segments displayed in spreadsheet form;

FIG. 3 is a flow chart illustrating the process of optimizing audio segments in a speech application program to account for programmed pauses and variable segments;

FIG. 4 is a listing of the optimized audio text in spreadsheet form where variables are replaced by values;

FIG. 5 a flow chart illustrating the process of optimizing code containing audio segments to account for duplicate segments;

FIG. 6 is a listing of the optimized code with multi-sentence segments separated into discrete sentences, alphabetized and compressed to minimize duplicate phrases;

FIG. 7 is a flow chart illustrating the process of optimizing code containing audio segments to account for the effects of coarticulation by using closed-class vocabulary analysis: and

FIG. 8 is listing of the audio segments of the code after closed-class vocabulary analysis.

### DETAILED DESCRIPTION OF THE PREFERRED EMBODIMENTS

The present invention is a system and method of automatically identifying planned audio segments within the program code of an interactive voice response program where the planned audio segments represent text that is to be recorded for audio playback (resulting in “actual audio segments”), and processes the text to produce manageable audio files containing text that can be easily translated to audio messages. Specifically, source code for a speech application written, for example, using VoiceXML, is analyzed and text that is to be reproduced as audio messages and all associated file names are identified. This text is then processed via a variety of optimization techniques that account for programmed pauses, the insertion of variables within the text, duplicate segments and the effects of coarticulation. The result is a file recordation plan in the form of a record of files that can be easily used by a voice professional to quickly and efficiently produce recorded audio segments (using the required file names) that will be used in the interactive voice response application.

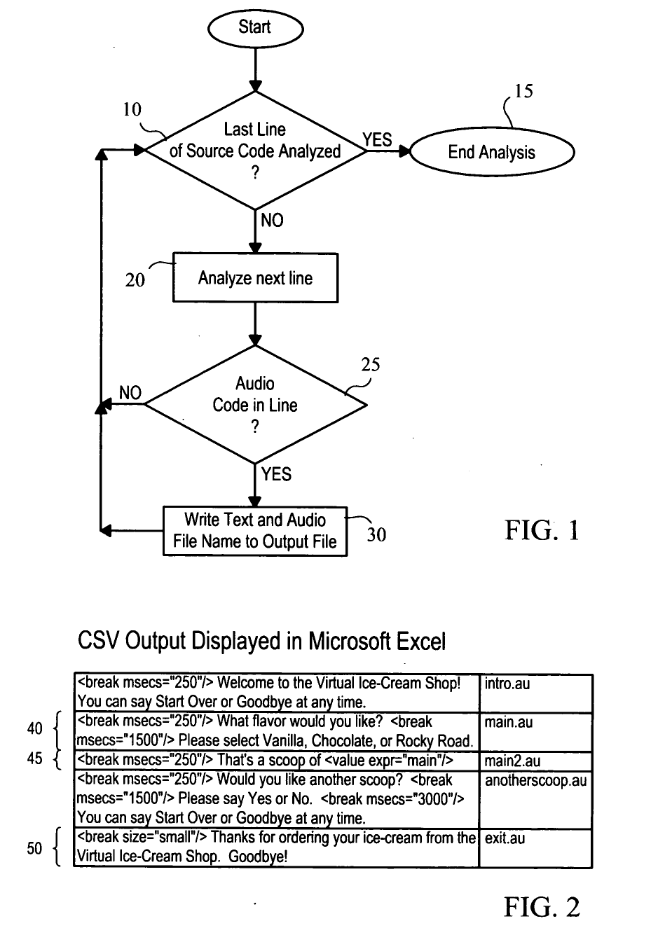

FIG. 1 is a flow chart illustrating the steps taken by the present invention to analyze and extract audio text to be recorded and associated file names in an interactive voice response (IVR) source program so the text within the source code may be easily converted into audio recordings with the correct file names. The process begins with a query to determine if all the lines of the source code have been analyzed (step 10). The source code is the code used in a typical interactive voice response (IVR) application program written, for example, using VoiceXML. If all lines of code have been analyzed, the process terminates at step 15. If more lines of code remain to be analyzed, the next line of code is analyzed at step 20 in order to determine if that next line of code contains a planned audio segment. As used herein, a “planned” audio segment is audio code in a speech application program that the programmer intends to be recorded thereby resulting in an “actual” audio segment. A planned audio segment includes the actual text that will be recorded and played back in an IVR application, i.e. “audio text”, any break or variable tags or other syntax associated with the audio text, and the file name associated with the planned recording. If no audio code is identified (step 25), the process reverts to block 10 where source code examination continues. If it is determined that audio code is present in the line of text being analyzed (step 25) the audio text and its associated elements (collectively, “planned audio segments”) are extracted and written to an audio text recordation plan such as an output file (step 30), where a voice recording professional can prepare audio recordings based upon the contents of the recordation plan.

VoiceXML, a sample IVR programming language, uses particular syntax to indicate the presence of audio code. For example, in a Voice XML application, an audio tag (<audio>) indicates the presence of audio code. Therefore, if the process of FIG. 1 is applied to a VoiceXML program, the next tag of VoiceXML code is examined and the system determines if the next tag is an audio tag. Therefore, if the system has recognized an initial audio tag, it expects audio code to follow. The text that appears between occurrences of “<audio>” and “</audio>” tags in a VoiceXML program is the planned audio segment that the programmer wants to be recorded. It may include only text, or it may include text and programmed pauses of a specified duration as well as variables.

FIG. 2 illustrates the recordation plan (a table of files) containing the extracted planned audio segments after the extraction routine in FIG. 1. In FIG. 2, the audio text that is to be recorded has been extracted from the lines of the speech application program. The planned audio segments in FIG. 2 can be saved in any desired format, for example, in Comma-Separated Value (.csv) format, as shown. The result can then be fed into a spreadsheet, as represented by the table shown in FIG. 2. The planned audio segments shown in FIG. 2 include the audio text and associated file names that the programmer wants to be recorded, as well as break and variable tags associated with the audio text. An advantage of saving the modified code in CSV format is that it is one of several proper forms to input into a teleprompter program designed to display text for recording and saving the recording as an assigned file name.

Even in the spreadsheet form shown in FIG. 2, the planned audio segments may need further modification in order for a voice recording professional to efficiently examine the planned segments and record corresponding audio text. It is unrealistic, not to mention costly and inefficient, to expect a voice professional to decipher the text lines as they appear in the planned audio segments of FIG. 2, including the break and value tags. Because it is feasible to automatically create silent audio files for specified durations, there is no need to include the <break> audio files in the output shown in FIG. 2. Therefore, the present invention provides a method to process the planned audio segments to provide the voice professional with an audio text recordation plan containing only the audio text that needs to be recorded, while taking into account planned programmed pauses that the programmer would like inserted into the voice stream. The system and method of the present invention preprocesses the extracted planned audio segments to encapsulate the break and value tags in their own audio code.

In certain languages, such as VoiceXML, a <break> tag indicates a period of silence that lasts for a specified duration if indicated in a time reference, i.e. milliseconds, or for a platform-dependent duration of specified size, for example, “small, or “medium”. For example, the planned audio segment 40 in FIG. 2, includes the syntax “<break msecs=“250”/> What flavor would you like?” which indicates that a silent pause of a duration of 250 milliseconds is to elapse before the audio text, “What flavor would you like?” is played. Alternately, in FIG. 2, the planned audio segment 50 includes the syntax “<break size=“small”/> Thanks for ordering your ice-cream from the Virtual Ice-Cream Shop”, which utilizes a size reference “small” in the break tag, to indicate a silent pause of a specified duration. Predetermined values for sizes (small, medium, large) may be, for example, 250 msec, 1,000 msec, and 5,000 msec, respectively. The present invention, when operating on VoiceXML program code for example, identifies all occurrences of <break> tags within the planned audio segment and creates a silent audio file that contains a programmed pause equal to the duration of the pause indicated in the planned segment. It then removes the <break> tag from the planned audio segment listing, leaving only the audio text that the voice recording professional needs to record. The silent audio recording is saved in a separate file and may be used for future programmed silent pauses of the same duration.

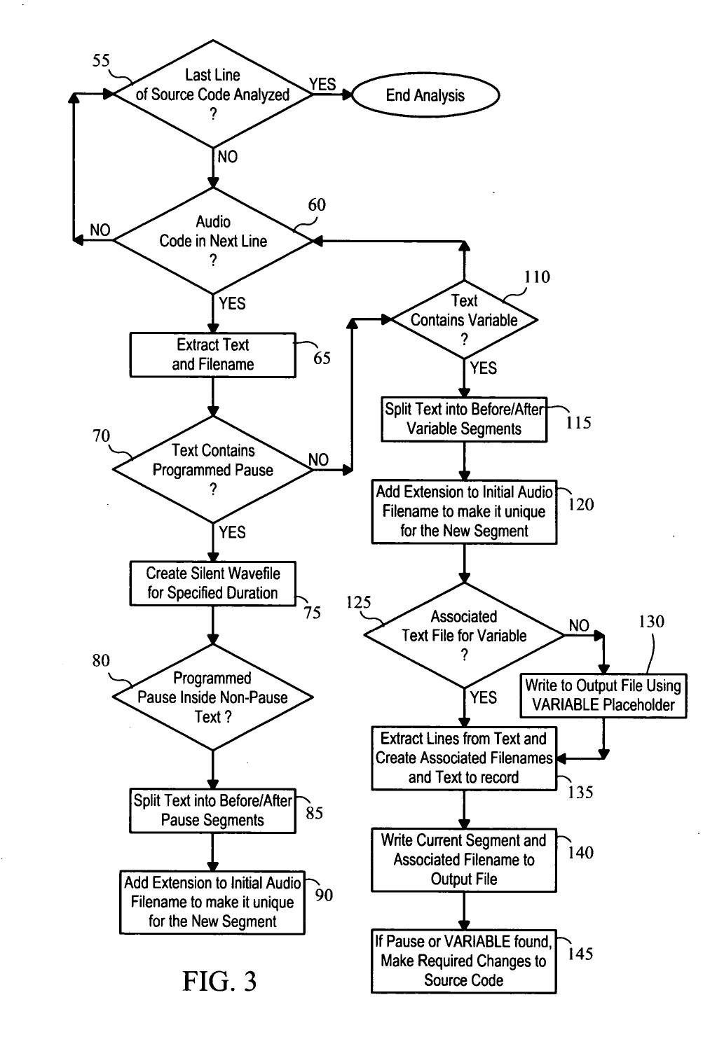

FIG. 3 is a flowchart that provides additional detail for the planned audio segment extraction routine of FIG. 1 and illustrates the steps taken by the present invention to optimize the planned audio segments in order to create audio files that account for programmed pauses. After the system determines that audio code is present (steps 55-65), the code is examined to determine if text indicating a programmed pause is present (step 70). If a programmed pause is present, an audio file containing silent audio of a specified duration is created (step 75). In some instances, the programmed pause occurs within the audio text. For example, in FIG. 2, line 40 indicates that a pause of 1500 msecs is required between the phrase “What flavor would you like” and the phrase “Please select Vanilla, Chocolate or Rocky Road”. In this instance, the present invention splits the text into two segments; a segment before the pause and a segment after the pause (steps 80 and 85) in FIG. 3. This results in an additional audio segment, i.e. the audio text occurring after the programmed pause. To account for this, a new file name is created (step 90), typically, similar to the file name of the planned audio segment prior to optimization but with a new extension to make it unique for the new planned audio segment.

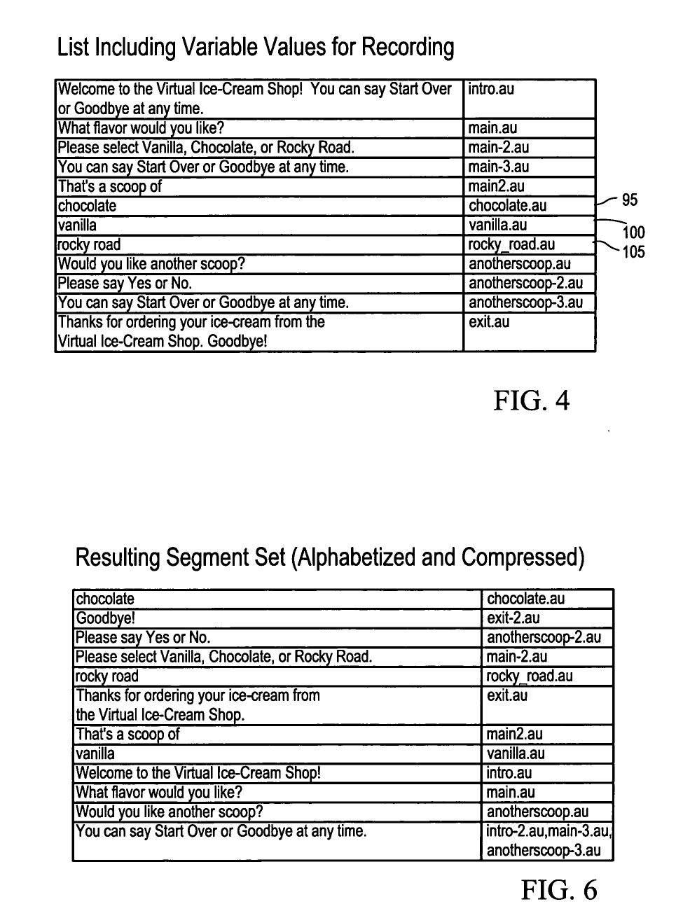

The audio text recordation plan of extracted audio segments of FIG. 2 also illustrates the use of value tags used in the speech application program to express the presence of a variable. Again, we assume that VoiceXML is the operative programming language for illustrative purposes. For other languages, the invention will identify appropriate audio segment indicators. The file named “main2.au” 45 in FIG. 2, includes the planned audio segment “That's a scoop of <value expr=“main”>” where a variable expression (main) for the flavor of ice cream is included rather than the actual value (i.e. the ice cream flavor). To account for <value> tags in audio segments, the present invention incorporates an optimization procedure similar to the one used to account for <break> tags in the source code. For example, the system recognizes the value tag “<value expr=“main/>” and an audio file named “VARIABLE”, for example, can be created to encapsulate the <value> tag, and create a placeholder in the table. If a list similar to the one of FIG. 2 is presented to a voice professional, the system can identify the VARABLE placeholders and filter out all the variable lines. Then, a decision can be made whether to record variable data. This depends upon the availability of resources, i.e. time and money, to do the recording. In the example presented above, the number of variables representing available ice cream flavors (vanilla, chocolate and rocky road) is relatively small. In this case, it is not cost or time prohibitive to record values for all the variables. If the decision is made to record all the values then it is possible to reference a file (or files) of values to produce the appropriate text and file names as shown in FIG. 4.

In FIG. 4, the file names “chocolate.au” 95, “vanilla.au” 100, and “rocky road.au” 105 represent audio files that include, as values, the possible choices of ice cream flavors. Therefore instead of a placeholder in the table, the table now includes files containing values that are to be recorded. By examining the file listing in FIG. 2, the voice professional can quickly determine the audio text that needs to be recorded for a specific voice application. If the choice is not to record the variable values, the system can play the values using text-to-speech (TTS). Therefore, if a scenario was presented where it would be impractical to record all the variable values, such as, for example, stock names, or airports around the world, then it would be desirable to replace the contents of the VARIABLE placeholder and minimize the cost by recording only the most frequently used (for example, in the above scenario, Microsoft®, Coca-Cola® for stock names, and La Guardia, Dulles, or Heathrow for airports), while allowing audio messages for all other values to be created via TTS technology. A simple search of .txt files can reveal the name of the variable in which the content of the .txt file are the values that the programmer intended to have recorded. Therefore, as opposed to the table of FIG. 2, the table shown in FIG. 4 does not include <break> or <value> tags and instead includes planned audio segments with only the audio text that needs to be recorded. Thus, the present invention results in a listing of planned audio segments presented to the voice professional that account for programmed pauses and variable values resulting in the recording of audio messages in an interactive voice response application in an efficient and cost-effective manner. The original source code can then be modified to include the optimized planned audio segments in their revised format.

Referring once again to FIG. 3, the process of optimizing planned audio segments and renaming audio files to account for variables is shown. First, it is determined if the source code contains text indicating a variable (step 110). If no variable is present, the process reverts back to step 60 where the next line of code is checked for audio content. If a variable is identified, step 115 splits the audio text into segments appearing before and after the variable. Step 120 adds an extension to the initial audio file name to indicate the presence of a variable. If there is no text file associated with the variable, an output file with a placeholder indicating the presence of a variable is created (steps 125-130). If there is text associated with the variable, the system extracts the lines of text and creates files with the text for recordation (step 135). In step 140, the planned audio segment and its associated file name is written to an output file. Finally step 145 updates the source code accordingly if a programmed pause or variable has been found.

Advantageously, the present invention also recognizes when duplicate text segments appear in speech application source code. Referring to the planned audio segment listing in FIG. 4, it can be seen that several phrases are repeated. For example, the phrase “You can say Start Over or Goodbye at any time” occurs in the file named “intro.au file”, the file named “main-3.au”, and the file named “anotherscoop-3.au”. Although there may be instances where a programmer would want two or more recordings of the identical message, such circumstances are rare. Instead, the number of recordings should be reduced for the purpose of reducing the expense of obtaining such recordings. The present invention identifies identical audio text in the extracted audio segments and reformats the text in the audio tags of the source file by first breaking multi-sentence segments into individual sentences.

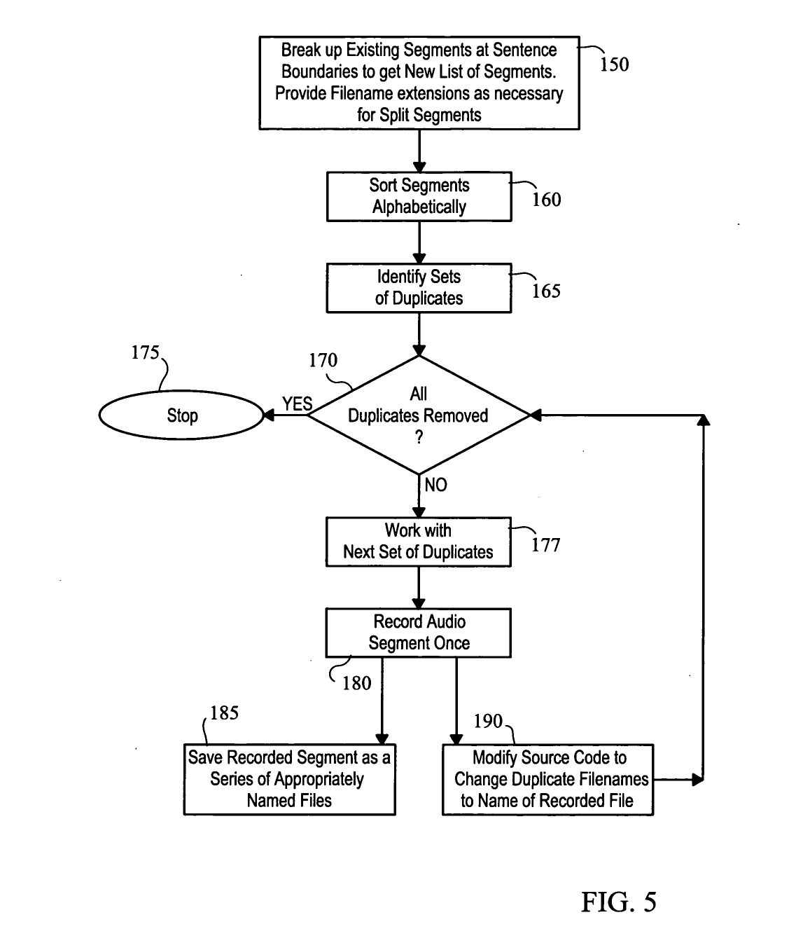

The process of the present invention to optimize the source code to account for duplicate planned audio segments is described with reference to the flowchart in FIG. 5. Step 150 generates a new list of planned segments by separating existing segments at sentence boundaries. The split segments are then given appropriate file names as new, planned audio segments. In one embodiment, the segments then can be sorted in order to provide the voice professional with an easier way to record the audio text. For example, after multi-sentence segments have been separated into discrete planned segments, the resulting list of planned audio segments may be sorted (step 160) and duplicate segments easily identified (step 165). The sorting may be alphabetical or in any other way that allows for the quick identification of duplicate sentences.

The listing in FIG. 6 shows the resulting planned audio segment set after multi-sentence lines have been separated, alphabetized and compressed to remove duplicate segments. Duplicate segments are identified by their multiple file names, which represent their multiple appearances in the source code. The system of the present invention can manage the occurrence of duplicate phrases in two ways. One option is that the duplicate phrase may be recorded once, and the duplicate files saved with the appropriate file names. Another option is to create a table that tracks equivalent files, and the table is used to modify the source code such that all duplicate references are resolved using the first reference in the list. Managing duplicate segments in this fashion requires fewer server resources although requiring additional code to account for the duplications.

Referring once again to the flowchart of FIG. 5, after duplicate segments have been identified, the system removes duplicate planned audio segments (step 170), in order to reduce the number of necessary audio recordings. If all the duplicate planned segments have been removed, the process ends at step 175. However, if additional duplicate planned segments remain, the process continues to identify subsequent sets of duplicate segments (step 177). Once the duplicate planned segments are identified, step 180 allows for one of the two options discussed above to be taken. The planned audio segment can be recorded once and saved as a series of files with appropriate file names to match the source code (step 185). Alternately, the planned audio segment can be recorded once and a table can be created that tracks equivalent files, and the table used to modify the source code so all duplicate references are resolved using the first reference in the table (step 190). In either case, the process reverts back to step 170 to determine if any duplicate planned segments remain to be analyzed.

To produce the best sounding audio segments from sentences that contain variable information, an additional embodiment to the system and method of the present invention takes the effects of coarticulation into account when determining the boundary between the static and variable parts of sentences. Coarticulation is a phenomenon that occurs in continuous speech as the articulators (e.g., tongue, lips, etc.) move during the production of speech but, due to the demands on the articulatory system, only approach rather than reach the intended target position. The acoustic effect of this is that the waveform for a phoneme is different depending on the immediately preceding and immediately following phoneme. Human listeners are not aware of this, as their brains compensate for these differences during speech comprehension. Human listeners, however, are very sensitive to the jarring effect that happens when they hear recorded speech segments in which the coarticulation effects are not consistent.

For example, taking the example used in the FIG. 2, audio segment 45 includes the line of text “That's a scoop of <value expr=“main”/>”. This indicates values that the variable “main” can take, for example, vanilla, chocolate, and rocky road. If spoken in normal continuous speech, the acoustics for the phoneme /f/ in the word “of” will be different when it's followed by the word “chocolate”, as in “That's a scoop of chocolate” than when it's followed by the word “vanilla”, as in “That's a scoop of vanilla” or “rocky road” as in ‘That’s a scoop of rocky road”. This is due to the effects of coarticulation. Therefore, it is impossible to have a single acoustic for /f/ that will sound correct when spliced with separate recordings of “vanilla”, “chocolate”, and “rocky road”.

Another aspect to consider is the effect of the phrase structure of language on the prosody of the production of words in a spoken sentence. Prosody is the pattern of stress, timing and intonation in a language. Sentences are composed of phrases such as noun phrases, verb phrases, and prepositional phrases. During the natural production of a sentence, there are prosodic cues, such as pauses, that help listeners parse the intended phrase structure of the sentence. In speech applications, the most common types of variable information are objects (nouns) rather than actions (verbs), which are usually, in the linguistic sense, objects of prepositions (and occasionally, verbs). In spoken language, there tends to be some separation (pause) between phrases. That separation might usually be slight, but listeners can tolerate some exaggeration of the pause as long as it's at a prosodically appropriate place. The longer the pause, the less the effect of coarticulation.

Phrases contain two types of words: function and content. These classes of words correspond to the linguistic classes of closed and open class words, respectively. The open (content) classes are nouns, verbs, adjectives and adverbs. Some examples of closed (function) classes are auxiliary verbs (e.g., did, have, be, etc.), determiners (a, an, the), and prepositions (to, for, of, etc.). Linguists call the open classes “open” because they are very open to the inclusion of new members. On almost a daily basis new nouns, verbs, adjectives and adverbs are created. The closed classes, on the other hand, are very resistant to the inclusion of new members. In any language, the number of members of the open classes is unknown because the classes are infinitely extensible. In contrast, the number of members of the closed classes is very few; typically, no more than a few hundred, of which a far smaller number are in general use.

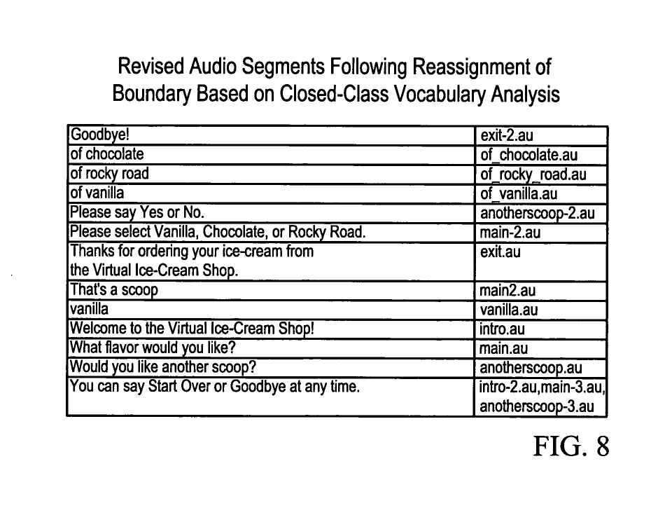

The present invention incorporates knowledge of the definition and properties of the closed class vocabulary to determine the boundary (in the linguistic sense), of a phrase. Using the example above, a line such as “That's a scoop of <value expr=“main”/>”, can be examined to determine the presence of closed and open class words. Working backward (right-to-left) from the <value> tag and checking for closed class words, the system determines that the preposition “of” is part of the closed class but that the word “scoop” is not. Based on this analysis, the boundary for recording the static text shifts, with the resulting change to the planned segments to record, shown in FIG. 8.

The system and method of the present invention are equally applicable to situations in which the variable information is in the middle of a sentence. Although this is a situation that many programmers try to avoid, it is often unavoidable. In a left-headed language such as English, where left-headed is a linguistic term that refers to the typical order in which types of words are arranged, phrases have a very strong tendency to end with objects (e.g., direct objects, objects of prepositional phrases), making it unnecessary to search to the right for closed-class words. Consider the text “One scoop of <value expr=“main”/> coming up!” The phrasing for this sentence is divided as follows: “One scoop”; “of <value expr=“main”/>”; “coming up!”. However, consider the following phrase: “That's a scoop of <value expr=“main”/> on your cone”. If the search is performed to the right, it could be concluded that the correct phrasing is “That's a scoop”; “of <value expr=“main”/> on your”; “cone”, because the words “on” and “your” are closed-class words. However, the system of the present invention does not search to the right, and instead parses the sentence into the following phrases: “That's a scoop”; “of <value expr=“main”/>”; “on your cone”, which is the proper phrasing.

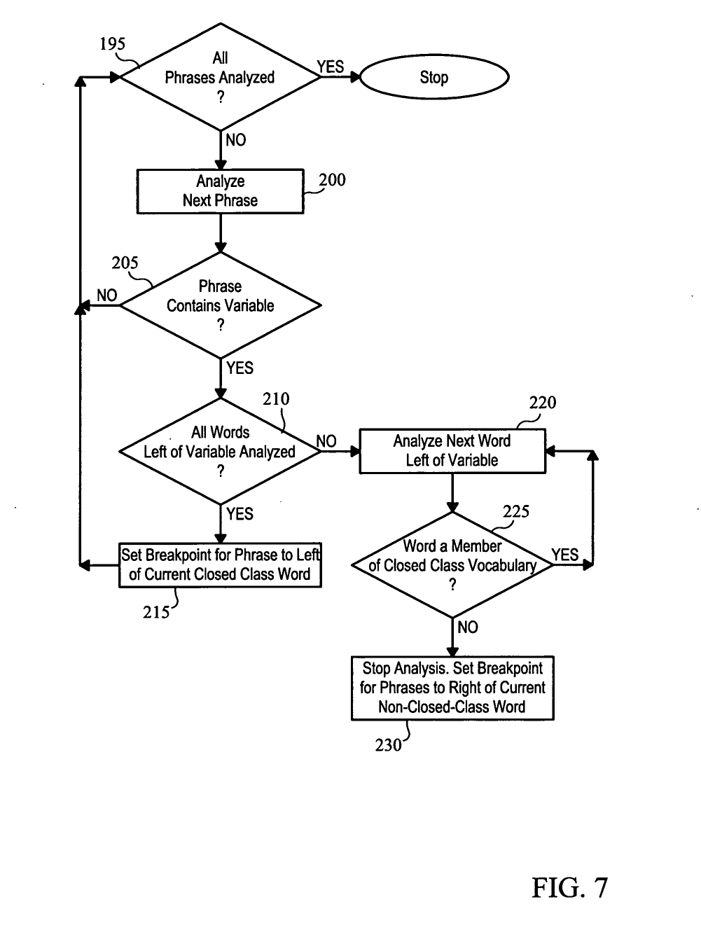

The process of optimizing the audio code to account for coarticulation using closed and open vocabulary analysis is shown in FIG. 7. Step 195 determines if all phrases in a body of code have been analyzed. If not, the next phrase of code is analyzed, at step 200. The system then determines if the phrase contains a variable (step 205). If the phrase does not contain a variable, the process reverts back to step 195. If the phrase does contain a variable, the system determines (step 210), if all words to the left of the variable have been analyzed. If all the words to the left of the variable have been analyzed, the system sets a breakpoint for a phrase to the left of the current closed class word (step 215). This phrase becomes a unique planned audio segment for the purposes of the table in FIG. 8. If there are words to the left of the variable that have not been analyzed, the word directly to the left of the variable is examined (step 220). Applying this process to the above example, “That's a scoop of <value expr=“main”/> on your cone”, the word to the left of the variable is “of”. The system examines this word and determines (step 225), if it is a closed class word. If it is, the process reverts back to step 220 and the next word to the left is analyzed. In the example given, “of” is a closed class word, so the next word to the left, “scoop” is examined. Because this word is not part of the closed class vocabulary, block 230 requires a breakpoint to be set for phrases to the right of the current non-closed class word, i.e. “scoop”. This results in the following phrasing segments: “That's a scoop”; “of <value expr=“main”/>; “on your cone”. Using the closed-class vocabulary technique of the present invention results in table shown in FIG. 8. The optimized planned audio segments are now separated to account for coarticulation effects and result in more natural sounding audio playback. Further, the table lists planned audio segments that are alphabetized, and compressed to remove duplicate segments. Programmed pause <breaks> have also been removed and silent audio files have been created. Finally, planned audio segments containing variables values have been created. Therefore, a voice professional can view the table of optimized audio segments shown in FIG. 8 and quickly and efficiently create clearly articulated audio recordings for any interactive voice response application.

The technique described above also extends to many cases in which a sentence contains multiple variables. After identifying the constituent phrases, the system applies an automatic file name as described above for each phrase. In one embodiment of the invention, a user interface is presented that allows users to edit the automatically selected boundaries to account for the possibility that the algorithm might occasionally miss the correct phrasing. Applying this feature results in a more natural sound when splicing audio segments, but can result in an inordinate number of segments to record if the same variable is used in different sentences with different closed-class words in front of the variable. For this reason, the system of the present invention includes an option to present developers with the ability to select or deselect this feature.

The features described above relate to any programming language that allows the programming of audio segments. Although VoiceXML is used as an example, the same techniques and strategies are applicable to other programming languages that allow the programming of audio segments and include as part of that programming the text that should be recorded for that audio segment. It is equally feasible to apply these techniques during code generation from a graphical representation of the program as to use them to recode portions of an existing program.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system having a central processing unit and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computer system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

1. A method of identifying planned audio segments in a speech application program, the method comprising:
identifying planned audio segments in the speech application program, the audio segments containing audio text to be recorded and associated file names;
extracting the audio segments from the speech application program; and
processing the extracted audio segments to create an audio text recordation plan.

2. The method of claim 1, wherein processing the extracted audio segments includes:
identifying text indicating a programmed pause of a specified duration in the extracted audio segments;
creating a silent audio file of the specified duration; and
modifying the audio segment containing the text indicating the programmed pause.

3. The method of claim 2, wherein processing the extracted audio segments further includes:
determining if the text indicating a programmed pause occurs within the audio text of the extracted audio segment; and
separating the audio text of the extracted audio segments into discrete audio text segments if the programmed pause occurs within the audio text of the extracted audio segment.

4. The method of claim 1, wherein processing the extracted audio segments includes:
identifying text indicating a variable in the extracted audio segments;
determining if the variable has an associated text file containing variable values;
creating a variable audio segment for each said variable value, if the variable has an associated text file; and
modifying the audio segment containing the text indicating the variable.

5. The method of claim 4, wherein processing the extracted audio segments further includes:
determining if the variable occurs within audio text of the audio segment; and
separating the audio text of the extracted audio segments into discrete audio text segments if the variable occurs within the audio text of the extracted audio segment.

6. The method of claim 1, wherein processing the extracted audio segments includes:
determining if the extracted audio segment contains more than one sentence of audio text; and
modifying the extracted audio segments to obtain audio segments containing only one sentence of audio text, if the extracted audio segments contain more than one sentence of audio text.

7. The method of claim 6, wherein processing the extracted audio segments further includes sorting the extracted audio segments.

8. The method of claim 7, wherein processing the extracted audio segments further includes:
identifiying an initial audio segment containing audio text;
identifying duplicate audio segments containing audio text identical to the audio text in the initial audio segment; and
deleting the duplicate audio segments.

9. The method of claim 1, wherein processing the extracted audio segments further includes:
identifying text indicating the presence of a variable in the extracted audio segment;
determining if a word immediately preceding the variable is a closed class word; and
separating the audio segment into first and subsequent discrete audio segments wherein the first discrete audio segment ends with the word preceding the variable that is not a closed class word.

10. The method of claim 1, wherein the speech application program language is VoiceXML.

11. A computer readable storage medium storing a computer program which when executed identifies and optimizes planned audio segments in speech application program, the computer program performing a method comprising:
identifying planned audio segments in the speech application program, the audio segments containing audio text to be recorded and associated file names;
extracting the audio segments from the speech application program; and
processing the extracted audio segments to create an audio text recordation plan.

12. The machine readable storage medium of claim 11, wherein processing the extracted audio segments further comprises:
identifying text indicating a programmed pause of a specified duration in the extracted audio segments;
creating a silent audio file of the specified duration; and
modifying the audio segment containing the text indicating the programmed pause.

13. The machine readable storage medium of claim 12, wherein processing the extracted audio segments further comprises:
determining if the text indicating a programmed pause occurs within the audio text of the extracted audio segment; and
separating the audio text of the extracted audio segments into discrete audio text segments if the programmed pause occurs within the audio text of the extracted audio segment.

14. The machine readable storage medium of claim 11, wherein processing the extracted audio segments further comprises:
identifying text indicating a variable in the extracted audio segments;
determining if the variable has an associated text file containing variable values;
creating a variable audio segment for each said variable value, if the variable has an associated text file; and
modifying the audio segment containing the text indicating the variable.

15. The machine readable storage medium of claim 14, wherein processing the extracted audio segments further comprises:
determining if the variable occurs within audio text of the audio segment; and
separating the audio text of the extracted audio segments into discrete audio text segments if the variable occurs within the audio text of the extracted audio segment.

16. The machine readable storage medium of claim 11, wherein processing the extracted audio segments comprises:
determining if the extracted audio segment contains more than one sentence of audio text; and
modifying the extracted audio segments to obtain audio segments containing only one sentence of audio text, if the extracted audio segments contain more than one sentence of audio text.

17. The machine readable storage medium of claim 16, wherein processing the extracted audio segments further includes sorting the extracted audio segments.

18. The machine readable storage medium of claim 17 wherein processing the extracted audio segments further comprises:
identifying an initial audio segment containing audio text;
identifying duplicate audio segments containing audio text identical to the audio text in the initial audio segment; and
deleting the duplicate audio segments.

19. The machine readable storage medium of claim 11, wherein processing the extracted audio segments further comprises:
identifying text indicating the presence of a variable in the extracted audio segment;
determining if a word immediately preceding the variable is a closed class word; and
separating the audio segment into first and subsequent discrete audio segments wherein the first discrete audio segment ends with the word preceding the variable that is not a closed class word.

20. The machine readable storage medium of claim 11, wherein the speech application program language is VoiceXML.

21. A system for extracting and optimizing planned audio segments in a speech application program, the audio segments containing audio text to be recorded and associated file names, the system comprising a computer having a central processing unit, the central processing unit extracting audio segments from a speech application program and processing the extracted audio segments in order to create an audio text recordation plan.

22. The system of claim 21, wherein processing the extracted audio segments includes identifying text indicating a programmed pause of a specified duration in the extracted audio segments, creating a silent audio file of the specified duration, and modifying the audio segment containing the text indicating the programmed pause.

23. The system of claim 22, wherein processing the extracted audio segments further includes determining if the text indicating a programmed pause occurs within the audio text of the extracted audio segment, and separating the audio text of the extracted audio segments into discrete audio text segments if the programmed pause occurs within the audio text of the extracted audio segment.

24. The system of claim 21, wherein processing the extracted audio segments further includes identifying text indicating a variable in the extracted audio segments, determining if the variable has an associated text file containing variable values, creating a variable audio segment to for each said variable value, if the variable has an associated text file, and modifying the audio segment containing the text indicating the variable.

25. The system of claim 24, wherein processing the extracted audio segments further includes determining if the variable occurs within audio text of the audio segment, and separating the audio text of the extracted audio segments into discrete audio text segments if the variable occurs within the audio text of the extracted audio segment.

26. The system of claim 21, wherein processing the extracted audio segments further includes determining if the extracted audio segment contains more than one sentence of audio text, and modifying the extracted audio segments to obtain audio segments containing only one sentence of audio text, if the extracted audio segments contain more than one sentence of audio text.

27. The system of claim 26, wherein processing the extracted audio segments further includes sorting the extracted audio segments.

28. The system of claim 27, wherein processing the extracted audio segments further includes identifiying an initial audio segment containing audio text, identifying duplicate audio segments containing audio text identical to the audio text in the initial segment, and deleting the duplicate audio segments.

29. The system of claim 21, wherein processing the extracted audio segments further includes identifying text indicating the presence of a variable in the extracted audio segment, determining if a word to immediately preceding the variable is a closed class word, and separating the audio segment into first and subsequent discrete audio segments wherein the first discrete audio segment ends with the word preceding the variable that is not a closed class word.
